(19) United States
(12) Patent Application Publication
(10) Pub. No.: US 2018/0149008 A1
(43) Pub. Date: May 31, 2018

(54) ENHANCING COMPLEX FRACTURE NETWORKS USING NEAR-WELLBORE AND FAR-FIELD DIVERSION

(71) Applicant: Halliburton Energy Services, Inc., Houston, TX (US)

(72) Inventors: Philip D. NGUYEN, Houston, TX (US); James William OGLE, Spring, TX (US); Tatyana V. KHAMATNUROVA, Houston, TX (US); Janette CORTEZ, Kingwood, TX (US)

(21) Appl. No.: 15/568,447

(22) PCT Filed: May 21, 2015
(86) PCT No.: PCT/US2015/032003

§ 371 Date: Oct. 20, 2017

(51) Int. Cl. E21B 43/267; C09K 8/68

(52) U.S. Cl. CPC E21B 43/267; C09K 8/887; C09K 8/685

(57) ABSTRACT

Methods comprising introducing a treatment fluid into a wellbore and through a perforation into a first propped main fracture at a first treatment interval above a fracture gradient of the subterranean formation, the treatment fluid comprising a first aqueous base fluid, expandable particulates, and degradable particulates; expanding the expandable particulates to fluidically seal the first propped main fracture to fluid flow between the first propped main fracture and the wellbore with the expanded expandable particulates and the degradable particulates; diverting the treatment fluid to a second treatment interval in the subterranean formation along the wellbore, wherein the rate of the treatment fluid creates or enhances a second main fracture therein; introducing a proppant fluid comprising a second aqueous base fluid and proppant particulates into the wellbore at the second treatment interval; and placing the proppant particulates into the second main fracture, thereby forming a second propped main fracture.

### BACKGROUND

The embodiments herein relate generally to subterranean formation operations and, more particularly, to enhancing complex fracture networks in a subterranean formation using near-wellbore and far-field diversion.

Hydrocarbon producing wells (e.g., oil producing wells, gas producing wells, and the like) are often stimulated by hydraulic fracturing treatments. In traditional hydraulic fracturing treatments, a treatment fluid, sometimes called a carrier fluid in cases where the treatment fluid carries particulates entrained therein, is pumped into a portion of a subterranean formation (which may also be referred to herein simply as a “formation”) above a fracture gradient sufficient to break down the formation and create one or more fractures therein. The term “treatment fluid,” as used herein, refers generally to any fluid that may be used in a subterranean application in conjunction with a desired function and/or for a desired purpose. The term “treatment fluid” does not imply any particular action by the fluid or any component thereof. As used herein, the term “fracture gradient” refers to a pressure (e.g., flow rate) necessary to create or enhance at least one fracture in a subterranean formation.

Typically, particulate solids, such as graded sand, are suspended in a portion of the treatment fluid and then deposited into the fractures. The particulate solids, known as “proppant particulates” or simply “proppant” serve to prevent the fractures from fully closing once the hydraulic pressure is removed. By keeping the fractures from fully closing, the proppant particulates form a proppant pack having interstitial spaces that act as conductive paths through which fluids produced from the formation may flow. As used herein, the term “proppant pack” refers to a collection of proppant particulates in a fracture, thereby forming a “propped fracture.” The degree of success of a stimulation operation depends, at least in part, upon the ability of the proppant pack to permit the flow of fluids through the interconnected interstitial spaces between proppant particulates.

The complexity of the fracture network (or “network complexity”) may be enhanced by stimulation operations to create new or enhance (e.g., elongate or widen) existing fractures. As used herein, the term “fracture network” refers to the access conduits, man-made or otherwise, within a subterranean formation that are in fluid communication with a wellbore. One such stimulation means involves the introduction of an acid alone or in a carrier fluid into a subterranean formation such that the acid contacts the subterranean formation or a desired portion of a subterranean formation (e.g., a fracture or portion of a fracture). The acid reacts with acid soluble materials contained in the subterranean formation, such as carbonate materials, thereby etching channels into the subterranean formation and increasing the permeability thereof. Such acid treatments may be combined with fracturing stimulation operations, termed “fracture-acidizing,” which involves fracturing a subterranean formation using an acid alone or in a carrier fluid such that the acid etches channels in the subterranean formation, including the formed or enhanced fractures created during the treatment, thereby creating flow-paths for the production of hydrocarbons.

### BRIEF DESCRIPTION OF THE DRAWINGS

The following FIGURE is included to illustrate certain aspects of the embodiments described herein, and should not be viewed as exclusive embodiments. The subject matter disclosed is capable of considerable modifications, alterations, combinations, and equivalents in form and function, as will occur to those skilled in the art and having the benefit of this disclosure.

FIG. 1 depicts an embodiment of a system configured for delivering various fluids of the embodiments described herein to a downhole location.

### DETAILED DESCRIPTION

The embodiments herein relate generally to subterranean formation operations and, more particularly, to enhancing complex fracture networks in a subterranean formation using near-wellbore and far-field diversion.

Specifically, the embodiments of the present disclosure relate to diversion operations for enhancing the generation of complex fracture networks during fracturing treatments, thereby enhancing the production of hydrocarbons therefrom. Such fracturing operations may include multistage fracturing treatments. As used herein, the term “multistage fracturing treatments,” and grammatical variants thereof (e.g., “multistage fracturing,” “multistage fracturing operations,” and the like) refers to a subterranean formation operation in which a plurality of reservoir intervals, or a plurality of locations within one or more reservoir intervals, in the subterranean formation are stimulated in succession. Examples of multistage fracturing treatments may include, but are not limited to, plug-and-perf operations, dissolvable plug-and-perf operations, continuous stimulation operations, and the like, and any combination thereof. For example, in some multistage fracturing treatments, a first fracture may be formed at a reservoir interval, followed by at least a second fracture formed at the same or a different reservoir interval. In some instances, multistage fracturing may involve fracturing a section of a reservoir interval, followed by plugging the fracture such that a treatment fluid may be diverted to a different location in the same reservoir interval or a different reservoir interval for forming a second fracture. The second fracture may then be plugged and the process repeated until the desired number of fractures are formed.

Other subterranean formation operations that may utilize the embodiments described herein may include, but are not limited to, refracturing operations (e.g., to add newly optimized perforated zones and initiate dominate fracture geometry), remedial treatments, completion operations, plugging casing operations, and the like, without departing from the scope of the present disclosure.

The embodiments described herein utilize expandable particulates, in combination with degradable particulates to perform fracturing operations, such as multistage operations. In particular, the expandable particulates are able to expand (or “swell”) to an expanded size greater than their non-expanded size, thus enhancing bridging and forming a tightly sealed pack with the degradable particulates to shut off fluid loss from a first fracture or set of fractures, even under high injection pressures. Accordingly, subsequent fracture(s) may be formed by diverting a treatment fluid to an unstimulated area of the subterranean formation for fracturing. This diversion may be performed both at a near-wellbore portion of the subterranean formation or at a far-field portion of the subterranean formation, as described in detail below, thereby allowing the formation of new fracture(s) and/or microfracture(s).

The embodiments described herein may advantageously form such fluid loss capability to enhance complex fracture networks by utilizing the expansion of expandable particulates, rather than a complex particle size distribution or particulate density method, utilizing expandable particulates hold in place other particulates such as the degradable particulates to ensure diversion occurs, and utilizing degradable particulates that are easily removed without additional equipment or fluids (although such may be utilized) to remove the fluid loss seal, which may also allow ease of removal of the expandable particulates. The embodiments herein may thus be cost effective and utilize already available equipment (e.g., pumping equipment) to enhance complex fracture networks.

As mentioned above, increasing fracture complexity in subterranean formations may increase the conductivity and productivity of the formation. Increasing fracture network complexity (e.g., keeping fractures, such as microfractures as described below, opened) greatly increases the surface area for the hydrocarbons (gas and/or oil) to desorb from the formation matrix, providing flow paths for these fluids to communicate with connected fractures and the wellbore for recovery.

In some embodiments, the complex fracture network enhancement methods and systems described herein may be utilized in traditional subterranean formations or in low-permeability subterranean formations, such as shale formations, tight-gas formations, and the like. The permeability of a formation is a measure of the formation's resistance to through-flow fluid. Thus, low-permeability formations require considerable applied pressure in order to flow fluid through its pore spaces, as compared to formations having higher permeabilities. As used herein, the term “low-permeability formation” refers to a formation that has a matrix permeability of less than 1,000 microdarcy (equivalent to 1 millidarcy). As used herein, the term “low-permeability formation” encompasses “ultra-low permeability formations,” which refers to a formation that has a matrix permeability of less than 1 microdarcy (equivalent to 0.001 millidarcy).

Examples of such low-permeability formations may include, but are not limited to, shale reservoirs and tight-gas sands. Shale reservoirs are sources of hydrocarbons comprising complex, heterogeneous rock with low permeability. Shale reservoirs may have permeabilities as low as less than about 0.001 millidarcy (“mD”) (9.869233×10⁻¹⁹ m²), and even as low as less than about 0.0001 mD (9.869233×10⁻²⁰ m²). Tight-gas sands are low permeability formations that produce mainly dry natural gas and may include tight-gas carbonates, tight-gas shales, coal-bed methane, and the like. Tight-gas sands may have permeabilities as low as less than about 1 mD (9.869233×10⁻¹⁶ m²), and even as low as less than about 0.01 mD (9.869233×10⁻¹⁸ m²).

One or more illustrative embodiments disclosed herein are presented below. Not all features of an actual implementation are described or shown in this application for the sake of clarity. It is understood that in the development of an actual embodiment incorporating the embodiments disclosed herein, numerous implementation-specific decisions must be made to achieve the developer's goals, such as compliance with system-related, lithology-related, business-related, government-related, and other constraints, which vary by implementation and from time to time. While a developer's efforts might be complex and time-consuming, such efforts would be, nevertheless, a routine undertaking for those of ordinary skill in the art having benefit of this disclosure.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” As used herein, the term “about” encompasses +/−5% of a numerical value. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

While compositions and methods are described herein in terms of “comprising” various components or steps, the compositions and methods can also “consist essentially of” or “consist of” the various components and steps. When “comprising” is used in a claim, it is open-ended.

As used herein, the term “substantially” means largely, but not necessarily wholly.

The embodiments described herein may provide for near-wellbore diverting during a multistage fracturing treatment. Such near-wellbore diversion may result in a fluid loss seal to be formed in a near-wellbore region of a main fracture, followed by fracturing of a second main fracture in the subterranean formation. As used herein, the term “near-wellbore region,” or simply “near-wellbore,” refers to an annular volume of a subterranean formation penetrated by wellbore from the outer diameter of the wellbore extending radially inward along a main fracture from the wellbore and into the formation a distance of no greater than about 10 meters (33 feet). As used herein, the term “main fracture,” refers to a primary fracture extending from a wellbore. A “branch fracture,” or simply “branch,” as used herein, refers to any fracture extending from a main fracture, or any non-primary fracture (e.g., a secondary fracture, a tertiary fracture, and the like) extending from a main fracture. Accordingly, a non-primary fracture that itself extends from a branch fracture is encompassed in the term “branch fracture.”

In some embodiments, the main fracture(s) may generally have a length in the range of from a lower limit of about 3 meters (“m”), 18 m, 33 m, 48 m, 63 m, 78 m, 93 m, 108 m, 123 m, 138 m, and 153 m to an upper limit of about 300 m, 285 m, 270 m, 255 m, 240 m, 225 m, 210 m, 195 m, 180 m, 165 m, and 150 m (equivalent to about 10 feet to about 1000 feet), encompassing any value and subset therebetween; and the branch fracture(s) may generally have a length in the range of from a lower limit of about 0.3 m, 0.9 m, 1.5 m, 2.1 m, 2.7 m, 3.3 m, 3.9 m, 4.5 m, 5.1 m, 5.7 m, 6.3 m, 6.9 m, and 7.5 to an upper limit of about 15 m, 14.4 m, 13.8 m, 13.2 m, 12.6 m, 12 m, 11.4 m, 10.8 m, 10.2 m, 9.6 m, 9 m, 8.4 m, 7.8 m, and 7.2 m (equivalent to about 1 feet to about 50 feet), encompassing any value and subset therebetween. Each of these values is critical to the embodiments described herein and may depend on a number of factors including, but not limited to, the type of subterranean formation being stimulated, the pressure (e.g., pump pressure) of the treatment fluid fracturing the subterranean formation, the type of treatment fluid fracturing the subterranean formation, and the like, and any combination thereof.

Additionally, the branch fractures of the present disclosure may, in some embodiments, have a fracture width or flow opening size in the range of from a lower limit of about 0.01 inch (in), 0.02 in, 0.03 in, 0.04 in, 0.05 in, 0.06 in, 0.07 in, 0.08 in, 0.09 in, 0.1 in, 0.12 in, 0.13 in, 0.14 in, 0.15 in, 0.16 in, 0.17 in, 0.18 in, 0.19 in, 0.2 in, 0.21 in, 0.22 in, 0.23 in, 0.24 in, and 0.25 in to an upper limit of about 0.5 in, 0.49 in, 0.48 in, 0.47 in, 0.46 in, 0.45 in, 0.44 in, 0.43 in, 0.42 in, 0.41 in, 0.4 in, 0.39 in, 0.38 in, 0.37 in, 0.36 in, 0.35 in, 0.34 in, 0.33 in, 0.32 in, 0.31 in, 0.3 in, 0.29 in, 0.28 in, 0.27 in, 0.26 in, and 0.25 in (equivalent to about 0.0254 centimeters (cm) to about 1.27 cm), encompassing any value and subset therebetween. Each of these values is critical to the embodiments described herein and may depend on a number of factors including, but not limited to, the type of subterranean formation being stimulated, the pressure (e.g., pump pressure) of the treatment fluid fracturing the subterranean formation, the type of treatment fluid fracturing the subterranean formation, closure stresses after hydraulic pressure is removed, and the like, and any combination thereof.

The fracture width or flow opening size of a main fracture is generally greater than the fracture width or flow opening size of a branch fracture. The main fractures and branch fractures described herein may be of any shape and may be formed by an ablation of any form that allows fluids to flow from the subterranean formation and into a wellbore, consistent with the descriptions provided herein.

As used herein, unless otherwise stated, the term “fracture” or “fractures” will refer collectively to both main fractures and branch fractures.

The embodiments described herein may provide for far-field diverting during a multistage fracturing treatment. Such far-field diversion may result in a fluid loss seal to be formed in a far-field region of a main fracture or a branch fracture, followed by fracturing of a first or second branch fracture in the subterranean formation. As used herein, the term “far-field region,” or simply “far-field” refers to an annular volume of a subterranean formation penetrated by wellbore from the outer diameter of the wellbore extending radially inward along a main fracture beyond the near-wellbore region, or along a branch fracture. In some instances, the far-field region may be beyond the main fracture tip into the subterranean formation, the main fracture tip the portion of the main fracture that permits growth of the main fracture.

The embodiments described herein provide methods comprising introducing a treatment fluid into a wellbore in a subterranean formation at a rate and pressure above the fracture gradient of the formation. As used herein, the term “fracture gradient” refers to the pressure required to induce fractures in a subterranean formation. The wellbore may have a perforation fluidly connecting the wellbore and a first propped main fracture at a first treatment interval. As used herein, the term “perforation” refers to any ablation, of any size and shape (e.g., cracks, slots, channels, holes, and the like), forming a tunnel extending beyond a wellbore and into a subterranean formation. When a wellbore comprises casing, cemented or un-cemented, the perforation forms a tunnel extending therethrough and into the formation. The perforation forms part of the near-wellbore region of a main fracture. As used herein, the term “treatment interval,” or simply “interval,” refers to a portion of a subterranean formation intended for production of fluids (e.g., hydrocarbons) therefrom.

The treatment fluid may comprise an aqueous base fluid, expandable particulates, and degradable particulates. Upon introduction of the treatment fluid into the wellbore at a rate and pressure above the fracture gradient, the expandable particulates and degradable particulates are placed into the first propped main fracture through the perforation in the near-wellbore region. Thereafter, the expandable particulates are expanded to fluidically seal the first propped main fracture to fluid flow between the first propped main fracture and the wellbore. The expanded expandable particulates comingle with the degradable particulates to form the fluidic seal. As used herein, the term “fluidically seal,” and grammatical variants thereof (e.g., “fluidically sealing,” “fluidic seal,” and the like), refers to a barrier that is capable of blocking fluid flow such that permeability of the barrier is no more than about 0.01 millidarcies (md) under natural conditions in a subterranean formation or during a subterranean formation operation (e.g., during a multistage fracturing operation as described herein). The fluidic seals described herein, regardless of whether they are in a main fracture or a branch fracture, are capable of diverting the treatment fluids described herein and maintaining their seal even under high perpendicular shear conditions (e.g., where multiple perforation clusters are used).

In some embodiments, the fluidic seal is formed in the near-wellbore region of the subterranean formation at a location of less than about 10 meters into the subterranean formation from the wellbore. In some embodiments, the fluidic seal is formed in the near-wellbore region of the subterranean formation at a location of no more than about 10 inches from the wellbore; that is, the fluidic seal may be formed at any point in the near wellbore region from the face of the wellbore and up to 10 inches extended radially into the formation from the wellbore. Each of these values is critical to the embodiments of the present disclosure and may depend on a number of factors including, but not limited to, the size and shape of the first propped main fracture, the size and shape of the expandable particulates, the expansion size of the expandable particulates, the size and shape of the degradable particulates, and the like, and any combination thereof.

The fluidic seal formed by the expanded expandable particulates, comingled with the degradable particulates, may thus divert the treatment fluid to a second treatment interval in the subterranean formation along the wellbore, where the treatment fluid being introduced above the fracture gradient creates or enhances a second main fracture thereat. In some embodiments, the pressure of the treatment fluid alone may cause such a second main fracture to be formed. In other embodiments, one or more second perforation(s) may be located at the second treatment interval to accept the introduction of the diverted treatment fluid therethrough to form the second main fracture(s).

After the second main fracture is formed, a proppant fluid comprising an aqueous base fluid and proppant particulates may be introduced into the subterranean formation such that it is also diverted from the fluidic seal formed in the first propped main fracture and to the second main fracture. The proppant particulates may then be placed into the second main fracture, thereby forming a second propped main fracture. The process of introducing the treatment fluid, forming a fluidic seal, and diverting the treatment fluid may be repeated to form at least a third main fracture at a third treatment interval. Additionally, the process of thereafter introducing the proppant fluid and placing the proppant particulates into the at least third main fracture may be repeated to form at least a third propped main fracture.

After repeating the near-wellbore diversion process described herein at the desired number of treatment intervals in the subterranean formation, the degradable particulates may be at least partially degraded either naturally over time, due to conditions of the wellbore environment, and/or upon exposure to a degradation agent that causes the degradation of the degradable particulates. In some embodiments, portions or all of the expandable particulates may also be degradable, and thus at least partially degraded as well, naturally over time, due to conditions of the wellbore environment, and/or upon exposure to a degradation agent that causes the degradation of all or a portion of the expandable particulates. As used herein, the term “degradation,” and grammatical variants thereof (e.g., degrading, and the like) refers to an amount of degradation necessary to restore fluid flow permeability through a fluidic seal described herein by at least 0.1 darcies. That is, in some instances, the degradable particulates may degrade such that the expandable particulates alone are incapable of remaining in the fracture(s) to form the fluidic seal. Accordingly, degradation of the degradable particulates may fluidically un-seal the fracture(s) to permit fluid flow. In other embodiments, degradation of the degradable particulates and all or a portion of the expandable particulates may fludicially un-seal the fracture(s) to permit fluid flow.

The first, second, and any additional propped main fractures may additionally interconnect at one or both of a near-wellbore region(s) and/or a far-field region(s) of the subterranean formation, thereby increasing fracture network complexity. As used herein, the term “interconnected,” and grammatical variants thereof (e.g., interconnection, and the like), refers fractures (main and branch fractures) that are in fluid communication, regardless of fluid flow permeability. In some instances, the first, second, and any additional propped main fractures may be interconnected in the near-wellbore region at a location in the range of a lower limit of about 1.5 meters (m), 1.75 m, 2 m, 2.25 m, 2.5 m, 2.75 m, 3 m, 3.25 m, 3.5 m, 3.75 m, 4 m, 4.25 m, 4.5 m, 4.75 m, 5 m, and 5.25 m to an upper limit of about 10 m, 9.75 m, 9.5 m, 9.25 m, 9 m, 8.75 m, 8.5 m, 8.25 m, 8 m, 7.75 m, 7.5 m, 7.25 m, 7 m, 6.75 m, 6.5 m, 6.25 m, 6 m, 5.75 m, 5.5 m, and 5.25 m into the formation from the wellbore (or about 5 feet to about 33 feet), encompassing any value and subset therebetween. In other embodiments, the first, second, and any additional propped main fractures may be interconnected in the far-field wellbore region at a location in the range of a lower limit of about 11 m, 15 m, 20 m, 25 m, 30 m, 35 m, 40 m, 45 m, 50 m, 55 m, 60 m, 65 m, 70 m, 75 m, 80 m, 85 m, 90 m, 95 m, 100 m, 110 m, 120 m, 130 m, 140 m, and 150 m to an upper limit of about 300 m, 290 m, 280 m, 270 m, 260 m, 250 m, 240 m, 230 m, 220 m, 210 m, 200 m, 190 m, 180 m, 170 m, 160 m, and 150 m into the formation from the wellbore (about 36 feet to about 984.3 feet), encompassing any value and subset therebetween. Each of these values is critical to the embodiments of the present disclosure and may depend on a number of factors including, but not limited to, the size and shape of the propped main fractures, the pressure of the introduced treatment fluid, and the like, and any combination thereof.

Additionally, the first, second, and any additional propped main fractures may further have their fracture network complexity increased by performing the diversion embodiments described below on branch fractures, without departing from the scope of the present disclosure.

The embodiments described herein provide methods comprising introducing a treatment fluid into a wellbore in a subterranean formation at a rate and pressure above the fracture gradient of the formation. The wellbore may have a perforation fluidly connecting the wellbore and a first main fracture. Further, the first main fracture may comprise a first propped branch fracture extending therefrom at a first treatment interval within the first main fracture.

The treatment fluid may comprise an aqueous base fluid, expandable particulates, and degradable particulates. Upon introduction of the treatment fluid into the wellbore at a rate and pressure above the fracture gradient, the expandable particulates and degradable particulates are placed into the first propped branch fracture through the perforation. Thereafter, the expandable particulates are expanded to fluidically seal the first propped branch fracture to fluid flow between the first propped branch fracture and the wellbore. The expanded expandable particulates comingle with the degradable particulates to form the fluidic seal.

In some embodiments, the fluidic seal of the branch fracture(s) is formed in the near-wellbore region of the subterranean formation at a location of less than about 10 meters into the subterranean formation from the wellbore. In some embodiments, the fluidic seal of the branch fracture(s) is formed in the near-wellbore region of the subterranean formation at a location in the range of a lower limit of about 1.5 meters (m), 1.75 m, 2 m, 2.25 m, 2.5 m, 2.75 m, 3 m, 3.25 m, 3.5 m, 3.75 m, 4 m, 4.25 m, 4.5 m, 4.75 m, 5 m, and 5.25 m to an upper limit of about 10, 9.75 m, 9.5 m, 9.25 m, 9 m, 8.75 m, 8.5 m, 8.25 m, 8 m, 7.75 m, 7.5 m, 7.25 m, 7 m, 6.75 m, 6.5 m, 6.25 m, 6 m, 5.75 m, 5.5 m, and 5.25 m into the formation from the wellbore (or about 5 feet to about 33 feet), encompassing any value and subset therebetween. In yet other embodiments, the branch fractures are located in the far-field region and the fluidic seal of the branch fracture(s) is formed in the far-field wellbore region of the subterranean formation at a location of further into the subterranean formation than the near-wellbore region. For example, in some embodiments, the fluidic seal of the branch fracture(s) is formed in the far-field wellbore region of the subterranean formation at a location in the range of a lower limit of about 11 m, 15 m, 20 m, 25 m, 30 m, 35 m, 40 m, 45 m, 50 m, 55 m, 60 m, 65 m, 70 m, 75 m, 80 m, 85 m, 90 m, 95 m, 100 m, 110 m, 120 m, 130 m, 140 m, and 150 m to an upper limit of about 300 m, 290 m, 280 m, 270 m, 260 m, 250 m, 240 m, 230 m, 220 m, 210 m, 200 m, 190 m, 180 m, 170 m, 160 m, and 150 m into the formation from the wellbore (about 36 feet to about 984.6 feet), encompassing any value and subset therebetween. Each of these values is critical to the embodiments of the present disclosure and may depend on a number of factors including, but not limited to, the size and shape of the first main fracture, the location of the branch fracture, the size and shape of the expandable particulates, the expansion size of the expandable particulates, the size and shape of the degradable particulates, and the like, and any combination thereof.

The fluidic seal of the first propped branch fracture formed by the expanded expandable particulates, comingled with the degradable particulates, may thus divert the treatment fluid to a second treatment interval in the first main fracture, where the treatment fluid being introduced above the fracture gradient creates or enhances a second branch fracture thereat. In some embodiments, the pressure of the treatment fluid alone may cause such a second branch fracture to be formed.

After the second branch fracture is formed, a proppant fluid comprising an aqueous base fluid and proppant particulates may be introduced into the subterranean formation such that it is also diverted from the fluidic seal formed in the first branch fracture and to the second branch fracture. The proppant particulates may then be placed into the second branch fracture, thereby forming a second propped branch fracture. The process of introducing the treatment fluid, forming a fluidic seal, and diverting the treatment fluid may be repeated to form at least a third branch fracture at a third treatment interval. Additionally, the process of thereafter introducing the proppant fluid and placing the proppant particulates into the at least third branch fracture may be repeated to form at least a third propped main fracture.

After repeating the near-wellbore diversion process described herein at the desired number of treatment intervals in the subterranean formation, the proppant fluid may be used to place proppant particulates into the first main fracture, thereby forming a first propped main fracture. Additionally, the degradable particulates may be at least partially degraded either naturally over time, due to conditions of the wellbore environment, and/or upon exposure to a degradation agent that causes the degradation of the degradable particulates. That is, in some instances, the degradable particulates may degrade such that the expandable particulates alone are incapable of remaining in the fracture(s) to form the fluidic seal. Accordingly, degradation of the degradable particulates may fluidically un-seal the fracture(s) to permit fluid flow.

The first, second, and any additional propped branch fractures may additionally interconnect at one or both of a near-wellbore region(s) and/or a far-field region(s) of the subterranean formation, thereby increasing fracture network complexity. In some instances, the first, second, and any additional propped branch fractures may be interconnected in the near-wellbore region at a location in the range of a lower limit of about 1.5 meters (m), 1.75 m, 2 m, 2.25 m, 2.5 m, 2.75 m, 3 m, 3.25 m, 3.5 m, 3.75 m, 4 m, 4.25 m, 4.5 m, 4.75 m, 5 m, and 5.25 m to an upper limit of about 10 m, 8.75 m, 8.5 m, 8.25 m, 8 m, 7.75 m, 7.5 m, 7.25 m, 7 m, 6.75 m, 6.5 m, 6.25 m, 6 m, 5.75 m, 5.5 m, and 5.25 m into the formation from the wellbore (or about 5 feet to about 30 feet), encompassing any value and subset therebetween. In other embodiments, the first, second, and any additional propped branch fractures may be interconnected in the far-field wellbore region at a location in the range of a lower limit of about 9.5 m, 10 m, 12 m, 14 m, 16 m, 18 m, 20 m, 22 m, 24 m, 26 m, 28 m, 30 m, 32 m, 34 m, and 36 m to an upper limit of about 60 m, 58 m, 56 m, 54 m, 52 m, 50 m, 48 m, 46 m, 44 m, 42 m, 40 m, 38 m, and 36 m into the formation from the wellbore (about 31.5 feet to about 200 feet), encompassing any value and subset therebetween. Each of these values is critical to the embodiments of the present disclosure and may depend on a number of factors including, but not limited to, the size and shape of the main fracture(s), the location of the branch fracture(s), the pressure of the introduced treatment fluid, and the like, and any combination thereof.

The expandable particulates of the present disclosure for use in the treatment fluids described herein may be any expandable particulates capable of forming the fluidic seals described herein in a wellbore environment, while comingling with the degradable particulates described herein. Generally, the expandable particulates are capable of expanding from an un-expanded form to an expanded form in an amount of from a lower limit of about 100%, 250%, 500%, 750%, 1000%, 1250%, 1500%, 1750%, 2000%, 2250%, 2500% to an upper limit of about 5000%, 4750%, 4500%, 4250%, 4000%, 3750%, 3500%, 3250%, 3000%, 2750%, and 2500% of their un-expanded form, encompassing any value and subset therebetween. Each of these values is critical to the embodiments described herein and the amount of expansion may depend on a number of factors including, but not limited to, the type of expandable particulate selected, the size of the main or branch fracture to be fluidically sealed, the duration of sealing required for the fluidic seal, and the like.

Generally, the expansion of the expandable particulates described herein may be naturally occurring upon encountering the aqueous base fluids of the treatment fluids described herein, or naturally occurring aqueous base fluids present within a subterranean formation. For example, some of the expandable particulates described herein are hydroscopic. In other instances, the expandable particulates may be expanded by contact with an expansion agent. Such expansion agents may include naturally occurring conditions within the subterranean formation environment such as, for example, temperature, pressure, pH, salinity, contact with hydrocarbons, and/or shear force. These expansion agents may additionally be introduced into the formation to encounter the expansion agents, such as by adjusting the pH or salinity of the treatment fluid. Other expansion agents may include chemical triggers, such as surfactant or solvent exposure, which may be placed into the subterranean formation to encounter the expandable particulates and form the fluidic seals described herein.

In some embodiments, the expandable particulates of the present disclosure in their un-expanded form may have a particle size distribution in the range of a lower limit of about 6 micrometers (μm), 50 μm, 100 μm, 150 μm, 200 μm, 250 μm, 300 μm, 350 μm, and 400 μm to an upper limit of about 850 μm, 800 μm, 750 μm, 700 μm, 650 μm, 600 μm, 550 μm, 500 μm, 450 μm, and 400 μm (about 2400 mesh to about 20 mesh, U.S. Standard Sieve), encompassing any value and subset therebetween. Each of these values is critical to the embodiments of the present disclosure and may depend on a number of factors including, but not limited to, the type of expandable particulate selected, the desired expansion size of the expandable particulate selected, the size of the main or branch fracture for forming the fluidic seal therein, and the like.

The term “expandable particulate,” as used in this disclosure, includes all known shapes of materials, including spherical materials, substantially spherical materials, fibrous materials, polygonal materials (such as cubic materials), fibrous materials, and combinations thereof. Each of these shapes is critical to the embodiments of the present disclosure and the selection of such shape may depend, at least in part, on the geometry of the main or branch fracture, the size of the main or branch fracture, the type of expandable particulate selected, and the like.

In some embodiments, the expandable particulates may be included in the treatment fluids of the present disclosure in an amount in the range of from a lower limit of about 5%, 6%, 7%, 8%, 9%, 10%, 11%, 12%, 13%, 14%, 15%, 16%, 17%, 18%, 19%, 20%, 21%, 22%, 23%, 24%, and 25% to an upper limit of about 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, and 25% by volume of the degradable particulates therein, encompassing any value and subset therebetween. In some embodiments, the range may be from about 10% to about 25% by volume of the degradable particulates therein. Each of these values is critical to the embodiments of the present disclosure and may depend on a number of factors including, but not limited to, the type of expandable particulate selected, the desired expansion size of the expandable particulate selected, the size of the main or branch fracture for forming the fluidic seal therein, the desired duration of the fluidic seal, and the like.

In some embodiments, at least a portion of the expandable particulates are hyaluronic acid-based particulates, hyaluronic acid-based coated particulates, blowing agents encapsulated by expandable material, memory foams, and any combination thereof. In some embodiments, the expandable material may additional degrade all or in part by one or more degradation agents, which, like the expansion agents, may be based on pH, salinity, temperature, hydrocarbon exposure, aqueous fluid exposure, chemical reactions, and the like.

The term “coating,” and grammatical variants thereof (e.g., “coat,” “coated,” and the like), as used herein refers to at least a partial coating of some or all of a particulate. One hundred percent coverage is not implied by the term “coating.” As used herein, the coating of the coating agents or encapsulating material described herein may be performed prior to a performing a subterranean formation operation, or may be performed on-the-fly at the wellsite. As used herein, the term “on-the-fly” refers to performing an operation during a subterranean treatment that does not require stopping normal operations. Such coating options may permit for a wide range of storage options and storage conditions (e.g., temperature conditions, humidity conditions, and the like).

The hyaluronic acid-based particulates and the hyaluronic acid-based coated particulates for use as the expandable particulates of the present disclosure may be of a hyaluronic acid-based material that is expandable because, as a negatively charged polyanionic polymer, the hyaluronic acid-based material has a strong affinity for water, a characteristic that explains its hydration capacity. As a non-limiting example, one gram of hyaluronic acid can bind up to six liters of water, occurring through the formation of hydrogen bonds with the carboxyl groups of the hyaluronic acid. Additionally, the hyaluronic acid-based material itself may degrade after the fluidic seal has performed its diversion function, such that the hyaluronic acid-based material degrades before, after, or simultaneously with the degradable particulates described herein. The hyaluronic acid-based material may degrade by enzymatic cleavage leading to free radicals that contributed to the degradation process. The hyaluronic acid-based material may include, but is not limited to, hyaluronic acid, hyaluronic acid hydrogels, a hyaluronic acid/flavonoid composite, a hyaluronic acid/collagen/hydroxyapatite composite, a hyaluronic acid/polylactic acid composite, hyaluronic acid/polyglycolic acid composite, a hyaluronic acid/acrylic acid composite, a hyaluronic acid/acrylic acid ester composite, a hyaluronic acid/polymethacrylate composite, a hyaluronic acid/poly(methyl methacrylate) composite, a hyaluronic acid/polysaccharide composite, a hyaluronic acid/cellulose derivative composite, a hyaluronic acid/polyvaleric acid composite, a hyaluronic acid/polybutyric acid composite, a hyaluronic acid/polycaproic acid composite, a potassium salt of hyaluronic acid, a magnesium salt of hyaluronic acid, a calcium salt of hyaluronic acid, an ester derivative of hyaluronic acid (e.g., an acetate, methacrylate, or acrylate derivative of hyaluronic acid, and the like), and any combination thereof. As used herein, the term “derivative” refers to any compound that is made from one of the listed compounds, for example, by replacing one atom in one of the listed compounds with another atom or group of atoms, ionizing one of the listed compounds, or creating a salt of one of the listed compounds.

The hyaluronic acid-based particulates and/or the hyaluronic acid-based coated particulates may provide a naturally occurring, environmentally free particulate type for forming the fluidic seals of the present disclosure. Additionally, the surface properties of such hyaluronic acid-based materials forming the particulates may provide for more efficient leakoff control compared to other traditional diverting agents.

The hyaluronic acid hydrogels may be formed by hyaluronic acid and/or composite materials with hyaluronic acid, including those described above, such that a polymer network is formed that expands in the presence of an aqueous base fluid. That is, the hyaluronic acid hydrogels are hydrophilic, sometimes colloidal gel, in which the dispersion medium is water, such that they expand in the presence of water while maintaining dimensional stability. The polymer network forming the hydrogel may be crosslinked. Such crosslinking may be with a metal crosslinker including, but not limited to, magnesium, calcium, zinc, titanium, zirconium, iron, boron, aluminum, and the like, and any combination thereof. The metal crosslinkers may be transient, such that the hydrogel may become de-crosslinked. Other more permanent or permanent crosslinkers may also be used in forming the hyaluronic acid hydrogels described herein, without departing from the scope of the present disclosure. For example, the hyaluronic acid hydrogel may comprise ester derivatized (e.g., acrylate, methacrylate, and the like) hyaluronic acid with radical initiators and diinitiators in the presence of hydrogen sulfide, disulfides, or bis initiators (e.g., bis thiol).

The hyaluronic acid-based coated particulates may be formed by coating one or more of the hyaluronic acid-based materials used described herein onto a particle. The particle may be a non-degradable particle (e.g., a proppant particulate), a degradable particle, and/or one or more of the expandable particulates, including those described herein, and the like, without departing from the scope of the present disclosure. The particles may be wet-coated, dry-coated, spray-coated or coated by adhesion with the hyaluronic acid-based material(s). For example, the below described tackifying agents may be used to adhere the hyaluronic acid-based material to the particle to form the hyaluronic acid-based coated particulates described herein, without departing from the present disclosure. In another example, the hyaluronic acid-based material may be spray coated onto a particle, such as a porous particle (e.g., ground nut shells).

In other embodiments, the hyaluronic acid-based coated particulates may be formed by chemically coupling hyaluronic acid to a silica particle with an organo-silane coupling agent. For example, in one embodiment, the silica particle may be tetraethylorthosilicate (i.e., a hydrolyzed silica particle) and the coupling agent may be 3-aminopropyltrimethoxysilane used to couple the tetraethylorthosilicate to hyaluronic acid to form the hyaluronic acid-based coated particulates described herein. Examples of other silica particles, in addition to tetraethylorthosilicate. Examples of other organo-silane coupling agents, in addition to 3-aminopropyltrimethoxysilane, may include, but are not limited to, N-2-(aminoethyl)-3-aminopropyltrimethoxysilane, 3-glycidoxypropyltrimethoxysilane, n-beta-(aminoethyl)-gamma-aminopropyltrimethoxysilane, and any combination thereof.

When the hyaluronic acid-based coated particulates are formed by chemically coupling hyaluronic acid to a silica particle with an organo-silane coupling agent, the hyaluronic acid-based material may be present in an amount from a lower limit of about 0.1%, 0.5%, 1%, 0.5%, 2%, 2.5%, 3%, 3.5%, 4%, 4.5%, and 5% to an upper limit of about 10%, 9.5%, 9%, 8.5%, 8%, 7.5%, 7%, 6.5%, 6%, 5.5%, and 5% by weight of the silica particles, encompassing any value and subset therebetween. Similarly, the organo-silane coupling agent may be present in an amount from a lower limit of about 0.01%, 0.02%, 0.03%, 0.04%, 0.05%, 0.06%, 0.07%, 0.08%, 0.09%, 0.1%, 0.11%, 0.12%, 0.13%, 0.14%, and 0.15% to an upper limit of about 0.3%, 0.29%, 0.28%, 0.27%, 0.26%, 0.25%, 0.24%, 0.23%, 0.22%, 0.21%, 0.2%, 0.19%, 0.18%, 0.17%, 0.16%, and 0.15% by weight of the hyaluronic acid-based material, encompassing any value and subset therebetween. Each of these values is critical to the embodiments herein and may depend on a number of factors including, but not limited to, the type of hyaluronic acid-based material selected, the type of organo-silane coupling agent selected, the desired expansion amount for forming the fluidic seal, and the like.

In some embodiments, at least a portion of the expandable particulates may be blowing agents encapsulated by expandable material. As used herein, the term “blowing agent” refers to a substance capable of expanding in volume due to a stimulus. The blowing agents may expand and push on the expandable material encapsulation, thereby expanding to form the fluidic seals described herein. In some embodiments, the blowing agents may produce a cellular structure that undergoes a hardening process or phase transition in the expandable material. In some embodiments, the blowing agents expand by exposure to a downhole environment, such as elevated downhole temperatures. Suitable blowing agents are typically in liquid, gaseous, or foam form. Examples of specific blowing agents for use in forming the expandable particulates of the present disclosure by encapsulation in an expandable material may include, but are not limited to, a hydrocarbon (e.g., pentane, isopentane, cyclopentane, and the like), liquid carbon dioxide, isocyanate, sodium bicarbonate, azo-based materials, hydrazine-based materials, nitrogen-based materials, titanium hydride, zirconium (II) hydride, and any combination thereof.

The expandable material for forming the expandable particulates formed from the blowing agents encapsulated in the expandable material may be any material capable of expanding upon action of the blowing agent. Such expandable materials may include, but are not limited to, a borate source (e.g., anhydrous boric acid, anhydrous sodium borate, sodium perborate monohydrate, and the like), a sodium salt of polyacrylic acid, a potassium salt of polyacrylic acid, a sodium salt of alginic acid, a potassium salt of alginic acid, a polyacrylate-cellulose graft polymer, collagen, chitin, chitosan, polylactic acid, polyglycolic acid, cellulose derivatives (e.g., carboxyalkylcellulose ethers, such as carboxyethylcellulose and carboxymethylcellulose; mixed ethers, such ascarboxymethyl-hydroxyethylcellulose; hydroxyalkylcelluloses, such as hydroxyethylcellulose and hydroxypropylcellulose; alkylhydroxyalkylcelluloses, such as methylhydroxypropylcellulose; alkylcelluloses, such as methylcellulose, ethylcellulose and propylcellulose; alkylcarboxyalkylcelluloses, such as ethylcarboxymethylcellulose; alkylalkylcelluloses, such as methylethylcellulose; hydroxyalkylalkylcelluloses, such as hydroxypropylmethylcellulose, and the like), salts of cellulose derivatives, polysaccharides, polymers or copolymers of acrylic acid, derivatives of acrylic acid (e.g., esters of acrylic acid), polyvaleric acid, dextran, carboxymethyldextran, starch, modified starch, hydroxyethyl starch, hydrolyzed polyacrylonitrile, polybutyric acid, polycaproic acid, starch-methacrylonitrile polymer, polyacrylamide, hydrolyzed polyacrylamide, a super absorbent polymer (e.g., cross-linked polyacrylates, polyacrylonitriles, polyvinylalcohols, polyethyleneoxides, polyvinylpyrrolidones, sulfonated polystyrene, hydrolysed polyacrylamides, and the like), and the like, and any combination thereof.

Like the hyaluronic acid-based particulates and the hyaluronic acid-based coated particulates, the all or part of the expandable material forming the blowing agent encapsulated in the expandable material may be degradable (e.g., the polylactic acid may expand to form the fluidic seal and then degrade over time). That is, some or all of the expandable material may be degradable by contact with a degradation agent, such as pH, salinity, temperature, contact with an aqueous fluid, contact with an oil-base fluid (e.g., hydrocarbon), chemical degradation, and the like, and any combination thereof. Depending on the expandable material, the degradable agent and the expansion agent may overlap such that the same agent first expands the expandable material and then later causes degradation, or where certain types of expandable material expand upon contact with a degradation agent that is different than the expansion agent that causes the expandable material to expand.

In some embodiments, the expandable material may be a memory foam. The memory foam expandable particulates may include, but are not limited to, polyurethane, polyethylene, ethylene vinyl acetate, latex, rubber, acrylic polyethylene, ethylene vinyl acetate, and a combination thereof. The memory foam expandable particulates may collapse under pressure, allowing them to mold tightly into irregular or regular geometries (e.g., under hydraulic pressure of a treatment fluid) to form the fluidic seals described herein. The memory foam expandable particulates after packing to form the fluidic seals may thereafter expand, attempting to attain their original (non-compressed) shape, thereby further enhancing the seal of the fluidic seal. In some embodiments, the memory foam expandable particulates are stabilized in an invert emulsion in an encapsulating material, as discussed below with reference to all of the expandable particulates. The memory foam expandable particulates may be prevented from expanding until at a desired downhole location, for example, by their placement in an oil-based fluid system or encapsulation, without departing from the scope of the present disclosure.

In some embodiments, a portion of the expandable particulates may further be selected from any of the materials used as the expandable material for forming the blowing agent encapsulated in expandable material particulates described above, without departing from the scope of the present disclosure. Some commercially expandable particulates that may be used as expandable particulates described herein or as the expandable material described herein may include, but are not limited to, EXPANCEL® Microspheres, expandable particulates, available from AkzoNobel in Amsterdam, The Netherlands; swellable and degradable microspheres available from DuPont in Wilmington, Del.; and CRYSTALSEAL™, expandable particulates, available from Halliburton Energy Services, Inc. in Houston, Tex.

The degradable particulates of the present disclosure may be composed of any degradable material capable of degrading upon contact with a degradation agent (e.g., pH, salinity, temperature, a hydrocarbon fluid, an aqueous base fluid, a chemical reactant, and the like).

In some embodiments, the degradable particulates of the present disclosure may have a particle size distribution in the range of a lower limit of about 6 micrometers (μm), 50 μm, 100 μm, 150 μm, 200 μm, 250 μm, 300 μm, 350 μm, and 400 μm to an upper limit of about 850 μm, 800 μm, 750 μm, 700 μm, 650 μm, 600 μm, 550 μm, 500 μm, 450 μm, and 400 μm (about 2400 mesh to about 20 mesh, U.S. Standard Sieve), encompassing any value and subset therebetween. Each of these values is critical to the embodiments of the present disclosure and may depend on a number of factors including, but not limited to, the type of expandable particulate selected, the concentration of the degradable particulate selected, the size of the main or branch fracture for forming the fluidic seal therein, and the like. In some embodiments, the size of the degradable particulates may be selected such that they mimic the size of the expandable particulates.

Like the expandable particulates, the term “degradable particulate,” as used in this disclosure, includes all known shapes of materials, including spherical materials, substantially spherical materials, fibrous materials, polygonal materials (such as cubic materials), fibrous materials, and combinations thereof. Each of these shapes is critical to the embodiments of the present disclosure and the selection of such shape may depend, at least in part, on the geometry of the main or branch fracture, the size of the main or branch fracture, the type of degradable particulate selected, and the like.

In some embodiments, the degradable particulates may be included in the treatment fluids of the present disclosure in an amount in the range of from a lower limit of about 1%, 2%, 3%, 4%, 5%, 6%, 7%, 8%, 9%, and 10% to an upper limit of about 20%, 19%, 18%, 17%, 16%, 15%, 14%, 13%, 12%, 11%, and 10% by volume of the total solid particulates therein, encompassing any value and subset therebetween. In some embodiments, the range may be from about 10% to about 25% by volume of the total solid particulates therein. Each of these values is critical to the embodiments of the present disclosure and may depend on a number of factors including, but not limited to, the type of degradable particulate selected, the type and concentration of expandable particulate selected, the size of the main or branch fracture for forming the fluidic seal therein, the desired duration of the fluidic seal, and the like.

Suitable degradable particulates for use in the embodiments described herein may include, but are not limited to, anhydrous boric oxide, anhydrous sodium borate, sodium perborate monohydrate, a degradable polymer, and any combination thereof. Suitable degradable polymers may include, but are not limited to, a poly(hydroxyl alkanoate), a poly(alpha-hydroxy) acid, a poly(beta-hydroxy alkanoate), a poly(omega-hydroxy alkanoate), a poly(alkylene dicarboxylate), a polyanhydride, a poly(orthoester), a polycarbonate, a poly(dioxepan-2-one), an aliphatic polyester, a poly(lactide), a poly(glycolide), a poly(ε-caprolactone, a poly(hydroxybutyrate), an aliphatic polycarbonate, a poly(amino acid), a poly(ethylene oxide), a polyphosphazene, and any combination thereof.

In some embodiments, one or both of the expandable particulates and/or the degradable particulates of the present disclosure may be coated with a coating agent to further improve performance thereof. Such coating agents may include, but are not limited to, a tackifying agent, a hydrophobic agent, a relative permeability modifier, and any combination thereof. Suitable coating agents may be used alone or in combination. In some embodiments, the coating agent may be present on the expandable and/or degradable particulates in an amount of from a lower limit of about 0.1%, 0.5%, 1%, 1.5%, 2%, 2.5%, 3%, 3.5%, 4%, 4.5%, and 5% to an upper limit of about 10%, 9.5%, 9%, 8.5%, 8%, 7.5%, 7%, 6.5%, 6%, 5.5%, and 5% by weight of the particulates (e.g., expandable and/or degradable), encompassing any value and subset therebetween. Each of these values is critical to the embodiments of the present disclosure and may depend on a number of factors including, but not limited to, the type of expandable and/or degradable particulate selected, the type of coating agent(s) selected, the desired functionality of the coating agent(s), and the like. In some embodiments, the entire surface or substantially the entire surface of the particulates may be coated with the coating agent(s).

The tackifying agent coating may enhance the homogeneous mixing and distribution of the expandable and degradable particulates during transport and packing to form the fluidic seals, thereby enhancing the sealing properties of the fluidic seal. Suitable tackifying agents may include, but are not limited to, a non-aqueous tackifying agent, an aqueous tackifying agent, a silyl-modified polyamide, and a reaction product of an amine and a phosphate ester, and any combination thereof. As used herein, the term “tacky” refers to a substance that is at least somewhat sticky to the touch. Accordingly, the expandable and/or degradable particulates coated with a tackifying agent may have a tendency to agglomerate together with other coated or uncoated expandable and/or degradable particulates, thus enhancing the fluidic seal.

The non-aqueous tackifying agents for use herein may comprise polyamides that are liquids or in solution at the temperature of the subterranean formation such that they are, by themselves, non-hardening when introduced into the subterranean formation. As an example, a non-aqueous tackifying agent suitable for use in the embodiments described herein may be a condensation reaction product comprised of a polyacid and a polyamine Such condensation reaction products may include, but are not limited to, compounds such as mixtures of C₃₆ dibasic acids containing some trimer and higher oligomers and also small amounts of monomer acids that are reacted with polyamines. Other polyacids include trimer acids, synthetic acids produced from fatty acids, maleic anhydride, acrylic acid, and the like. Additional compounds which may be used as non-aqueous tackifying compounds may include, but are not limited to, liquids and solutions of, for example, polyesters, polycarbonates and polycarbamates, natural resins such as shellac and the like.

Aqueous tackifying agents suitable for use in the present disclosure are not significantly tacky when placed onto a particulate (e.g., expandable or degradable), but are capable of being “activated” (that is destabilized, coalesced and/or reacted) to transform the compound into a sticky, tackifying compound at a desirable time. Such activation may occur before, during, or after the aqueous tackifying agent is placed in the subterranean formation. In some embodiments, a pretreatment may be first contacted with the surface of an expandable and/or degradable particulate to prepare it to be coated with the aqueous tackifying agent.

Suitable aqueous tackifying agents are generally charged polymers that comprise compounds that, when in an aqueous solvent or solution, will form a non-hardening coating (by itself or with an activator) and, when placed on a particulate (e.g., expandable and/or degradable), will increase the continuous critical resuspension velocity thereof when contacted by a stream of aqueous fluid. The aqueous tackifying agent may enhance the grain-to-grain contact between the individual particulates (e.g., expandable and/or degradable) within the formation, helping bring about the consolidation of the particulates into a cohesive, and flexible mass, thereby facilitating formation of the fluidic seal.

Suitable aqueous tackifying agents include any polymer that can bind, coagulate, or flocculate a particulate (e.g., expandable and/or degradable). Also, polymers that function as pressure sensitive adhesives may be suitable. Examples of aqueous tackifying agents suitable for use in the present disclosure may include, but are not limited to acrylic acid polymers, acrylic acid ester polymers, acrylic acid derivative polymers, acrylic acid homopolymers, acrylic acid ester homopolymers (e.g., poly(methyl acrylate), poly (butyl acrylate), poly(2-ethylhexyl acrylate), and the like), acrylic acid ester co-polymers, methacrylic acid derivative polymers, methacrylic acid homopolymers, methacrylic acid ester homopolymers (e.g., poly(methyl methacrylate), poly(butyl methacrylate), poly(2-ethylhexyl methacrylate), and the like), acrylamido-methyl-propane sulfonate polymers, acrylamido-methyl-propane sulfonate derivative polymers, acrylamido-methyl-propane sulfonate co-polymers, acrylic acid/acrylamido-methyl-propane sulfonate co-polymers, any derivatives thereof, and any combination thereof. The term “derivative” as used herein refers to any compound that is made from one of the listed compounds, for example, by replacing one atom in the base compound with another atom or group of atoms.

Other suitable aqueous tackifying agents may comprise at least one member selected from the group consisting of benzyl coco di-(hydroxyethyl) quaternary amine, p-T-amyl-phenol condensed with formaldehyde, and a copolymer comprising from about 80% to about 100% C₁₋₃₀ alkylmethacrylate monomers and from about 0% to about 20% hydrophilic monomers. In some embodiments, the aqueous tackifying agent may comprise a copolymer that comprises from about 90% to about 99.5% 2-ethylhexylacrylate and from about 0.5% to about 10% acrylic acid. Suitable hydrophillic monomers may be any monomer that will provide polar oxygen-containing or nitrogen-containing groups. Suitable hydrophillic monomers include dialkyl amino alkyl(meth)acrylates and their quaternary addition and acid salts, acrylamide, N-(dialkyl amino alkyl)acrylamide, methacrylamides and their quaternary addition and acid salts, hydroxy alkyl(meth)acrylates, unsaturated carboxylic acids such as methacrylic acid or preferably acrylic acid, hydroxyethyl acrylate, acrylamide, and the like, and any combination thereof. These copolymers can be made by any suitable emulsion polymerization technique.

Silyl-modified polyamide compounds suitable for use as a tackifying agent in the embodiments described herein may be described as substantially self-hardening compositions that are capable of at least partially adhering to particulates (e.g., expandable and/or degradable) in the unhardened state, and that are further capable of self-hardening themselves to a substantially non-tacky state to which individual particulates such as formation fines will not adhere to, for example, after the expandable particulates have expanded. Such silyl-modified polyamides may be based, for example, on the reaction product of a silating compound with a polyamide or a mixture of polyamides. The polyamide or mixture of polyamides may be one or more polyamide intermediate compounds obtained, for example, from the reaction of a polyacid (e.g., diacid or higher) with a polyamine (e.g., diamine or higher) to form a polyamide polymer with the elimination of water.

Yet another tackifying agent suitable for use in the present disclosure is a reaction product of an amine and a phosphate ester. The ratio of amine to phosphate ester combined to create the reaction product tackifying agent is preferably from a lower limit of about 1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, and 2.5:1 to an upper limit of about 5:1, 4.9:1, 4.8:1, 4.7:1, 4.6:1, 4.5:1, 4.4:1, 4.3:1, 4.2:1, 4.1:1, 4:1, 3.9:1, 3.8:1, 3.7:1, 3.6:1, 3.5:1, 3.4:1, 3.2:1, 3.1:1, 3:1, 2.9:1, 2.8:1, 2.7:1, 2.6:1, and 2.5:1, encompassing any value and subset therebetween. For example, in some embodiments, the ratio may be from about 2:1 to about 3:1. In some embodiments it may be desirable to combine the amine and phosphate ester in the presence of a solvent, such as methanol.

To create these amine/phosphate ester tackifying agents, suitable amines may include, without limitation, any amine that is capable of reacting with a suitable phosphate ester to form a composition that forms a deformable coating on a metal-oxide-containing surface. Examples of such amines may include, without limitation, any amine of the general formula R¹,R²NH or mixtures or combinations thereof, where R¹ and R² are independently a hydrogen atom or a carbyl group having between about between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof.

Examples of amines suitable for use in this disclosure may include, without limitation, aniline and alkyl anilines or mixtures of alkyl anilines, pyridines and alkyl pyridines or mixtures of alkyl pyridines, pyrrole and alkyl pyrroles or mixtures of alkyl pyrroles, piperidine and alkyl piperidines or mixtures of alkyl piperidines, pyrrolidine and alkyl pyrrolidines or mixtures of alkyl pyrrolidines, indole and alkyl indoles or mixture of alkyl indoles, imidazole and alkyl imidazole or mixtures of alkyl imidazole, quinoline and alkyl quinoline or mixture of alkyl quinoline, isoquinoline and alkyl isoquinoline or mixture of alkyl isoquinoline, pyrazine and alkyl pyrazine or mixture of alkyl pyrazine, quinoxaline and alkyl quinoxaline or mixture of alkyl quinoxaline, acridine and alkyl acridine or mixture of alkyl acridine, pyrimidine and alkyl pyrimidine or mixture of alkyl pyrimidine, quinazoline and alkyl quinazoline or mixture of alkyl quinazoline, or mixtures or combinations thereof.

For the phosphate ester component of the amine/phosphate ester tackifying agents, suitable phosphate esters may include, without limitation, any phosphate ester that is capable of reacting with a suitable amine to form a composition that forms a deformable coating on a metal-oxide containing surface or partially or completely coats particulate materials. Examples of such phosphate esters may include, without limitation, any phosphate esters of the general formula P(O)(OR)(OR⁴)(OR⁵) or mixture or combinations thereof, where R³, R⁴, and OR⁵ are independently a hydrogen atom or a carbyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof. Examples of phosphate esters may include, without limitation, phosphate ester of alkanols having the general formula P(O)(OH)ₓ(OR⁶)_{y} where x+y=3 and are independently a hydrogen atom or a carbyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof such as ethoxy phosphate, propoxyl phosphate or higher alkoxy phosphates or mixtures or combinations thereof.

Other examples of phosphate esters include, without limitation, phosphate esters of alkanol amines having the general formula N[R⁷OP(O)(OH)₂]₃ where R⁷ is a carbonyl group having between about 1 and 40 carbon atoms and the required hydrogen atoms to satisfy the valence and where one or more of the carbon atoms can be replaced by one or more hetero atoms selected from the group consisting of boron, nitrogen, oxygen, phosphorus, sulfur or mixture or combinations thereof and where one or more of the hydrogen atoms can be replaced by one or more single valence atoms selected from the group consisting of fluorine, chlorine, bromine, iodine or mixtures or combinations thereof group including the tri-phosphate ester of tri-ethanol amine or mixtures or combinations thereof.

Other examples of phosphate esters include, without limitation, phosphate esters of hydroxylated aromatics such as phosphate esters of alkylated phenols such as nonylphenyl phosphate ester or phenolic phosphate esters. Other examples of phosphate esters include, without limitation, phosphate esters of diols and polyols such as phosphate esters of ethylene glycol, propylene glycol, or higher glycolic structures. Other phosphate esters include any phosphate ester than can react with an amine and coated on to a substrate forms a deformable coating enhancing the aggregating potential of the substrate.

The hydrophobic agent and relative permeability modifier for use in the embodiments of the present disclosure for coating onto the expandable and/or degradable particulates may enhance the performance of the fluidic seal by preventing or reducing water-based leakoff. Suitable hydrophobic agents for coating onto the particulates described herein (e.g., expandable and/or degradable) may include, but are not limited to styrene-butadiene rubber latex, a wax (e.g., a low melting polyolefin wax), an oil, a fatty oil, a fatty acid, a fatty ester, polybutylene, an atactic polyolefin, and any combination thereof. Suitable relative permeability modifiers for use in coating the expandable and/or degradable particulates of the present disclosure may include, but are not limited to, acrylamide/octadecyldimethylammoniumethyl methacrylate bromide copolymer, dimethylaminoethyl methacrylate/vinyl pyrrolidone/hexadecyldimethylammoniumethyl methacrylate bromide terpolymer, acrylamide/2-acrylamido-2-methyl propane sulfonic acid/2-ethylhexyl methacrylate terpolymer, an amino methacrylate/alkyl amino methacrylate copolymer, a dimethylaminoethyl methacrylate/alkyl-dimethylammoniumethyl methacrylate copolymer (e.g., dimethylaminoethyl methacrylate/hexadecyl-dimethylammoniumethyl methacrylate copolymer). These copolymers and terpolymers may be formed by reactions with a variety of alkyl halides.

In some embodiments, the expandable particulates and/or the degradable particulates may be encapsulated in an encapsulating material. Encapsulating materials suitable for use in the present disclosure may be substances that are capable of coating onto the particulates for a variety of purposes, such as to delay expansion of the expandable particulates, to delay contact between the expandable particulates and/or the degradable particulates that have been coated with a coating agent, as described herein, to delay degradation of the degradable particulates, and the like. Encapsulating materials suitable for use in the present disclosure may dissipate or otherwise release particulates (e.g., expandable and/or degradable) once the particulates are contacted with a treatment fluid, or after a period of time within the treatment fluid, or upon exposure to a downhole environment condition (e.g., pH, salinity, temperature, shear force, and the like). The terms “dissipate” and “otherwise release” as used herein refers to at least a partial release of the encapsulating material from at least some of the particulates. One hundred percent release of the encapsulating material from the particulates is not implied by the terms “dissipate” or “otherwise release.” Suitable encapsulating materials may be used alone or in combination. In some embodiments, the encapsulating material may be present on the expandable and/or degradable particulates alone or after being coated with a coating agent in an amount of from a lower limit of about 0.1%, 0.5%, 1%, 1.5%, 2%, 2.5%, 3%, 3.5%, 4%, 4.5%, and 5% to an upper limit of about 10%, 9.5%, 9%, 8.5%, 8%, 7.5%, 7%, 6.5%, 6%, 5.5%, and 5% by weight of the particulates or coated particulates (e.g., expandable and/or degradable), encompassing any value and subset therebetween. Each of these values is critical to the embodiments of the present disclosure and may depend on a number of factors including, but not limited to, the type of expandable and/or degradable particulate selected, the type of coating agent(s) selected, the type of encapsulating material(s) selected, and the like. In some embodiments, the entire surface or substantially the entire surface of the particulates or coated particulates may be encapsulated with the encapsulating material(s).

In one embodiment, the encapsulating material may be a hydratable polymeric material. As used herein, the term “hydratable polymeric material” refers to any type of polymer that may be formed into a powder when dehydrated and is at least partially soluble in an aqueous fluid or a fluid that is miscible with an aqueous solution (e.g., an alcohol, a glycol, etc.). As a result of being at least partially soluble in an aqueous fluid or a fluid that is miscible with an aqueous fluid, the hydratable polymeric material may dissipate to some degree when the encapsulated particulates are placed into a fluid. In one embodiment, the hydratable polymeric material may comprise a polysaccharide derivative that may be an organic hydratable polymeric material. Examples of suitable organic hydratable polymeric materials that may dissolve or otherwise dissipate in a treatment fluid described herein may include, but are not limited to, a starch powder obtained from corn, wheat, potatoes, barley, beans, cassava, or any other plant starch. Alternative organic hydratable polymeric materials may include, but are not limited to, grain powders such as those obtained from rice, corn, wheat, beans, or guar gums. In some embodiments, the organic encapsulating materials of the present disclosure may comprise a powder with a particle size of less than about 30 μm. In other embodiments, the organic hydratable polymeric materials may have a size of less than about 10 μm.

Other encapsulating materials for use in the embodiments of the present disclosure may include, but are not limited to, a wax, polyvinyl alcohol, a polymer, a protein, a polysaccharide, or any degradable material forming the degradable particulates above that are capable of being coated onto the expandable and/or degradable particulates and serving to encapsulate the particulates for a period of time. Examples of such encapsulating materials may include, but are not limited to, polylactic acid, polyglycolic acid, a polyamide, a polyalkylene glycol (e.g., polyethylene glycol), polyvinyl alcohol, polyvinyl ester, polysiloxane, polyurethane, polyurethane copolymers, polyacrylic acid, a polyacrylic acid derivative, collagen, gelatin, a cellulose derivative (e.g., alkyl cellulose, hydroxyalkyl cellulose, cellulose acetate, and the like), and any combination thereof.

The aqueous base fluid for use in forming the treatment fluids and proppant fluids of the present disclosure may include, but are not limited to, fresh water, saltwater (e.g., water containing one or more salts dissolved therein), brine (e.g., saturated salt water), seawater, and any combination thereof. Generally, the water may be from any source, provided that it does not contain components that might adversely affect the stability and/or performance of the treatment fluids or proppant fluids of the embodiments of the present disclosure. In certain embodiments, the density of the aqueous base fluid can be adjusted, among other purposes, to provide additional particulate transport and suspension. In certain embodiments, the pH of the aqueous base fluid may be adjusted (e.g., by a buffer or other pH adjusting agent), among other purposes, to activate a crosslinking agent and/or to reduce the viscosity of the treatment fluid and/or proppant fluid (e.g., activate a breaker, deactivate a crosslinking agent). In these embodiments, the pH may be adjusted to a specific level, which may depend on, among other factors, if any additives are included in the treatment and/or proppant fluid, such as gelling agents, acids, and the like.

The proppant particulates described herein may be any material capable of propping open a fracture after hydraulic pressure is removed. The term “proppant particulate,” as used in this disclosure, includes all known shapes of materials, including spherical materials, substantially spherical materials, fibrous materials, polygonal materials (such as cubic materials), fibrous materials, and combinations thereof. Each of these shapes is critical to the embodiments of the present disclosure and the selection of such shape may depend, at least in part, on the geometry of the main or branch fracture, the size of the main or branch fracture, the type of proppant particulate selected, and the like.

Suitable materials for the proppant particulates may include, but are not limited to, sand, bauxite, ceramic material (e.g., ceramic microspheres), glass material, polymeric material (e.g., ethylene-vinyl acetate or composite materials), zeolites, polytetrafluoroethylene material, nut shell pieces, a cured resinous particulate comprising nut shell pieces, seed shell pieces, a cured resinous particulate comprising seed shell pieces, fruit pit pieces, a cured resinous particulate comprising fruit pit pieces, wood, composite particulates, and any combination thereof. Suitable composite particulates may comprise a binder and a filler material, wherein suitable filler materials may include, but are not limited to, silica, alumina, fumed carbon, carbon black, graphite, mica, titanium dioxide, barite, meta-silicate, calcium silicate, kaolin, talc, zirconia, boron, fly ash, hollow glass microspheres, solid glass, and any combination thereof.

In some embodiments, the proppant particulates may have an average particle size distribution in the range of from a lower limit of about 100 μm, 200 μm, 300 μm, 400 μm, 500 μm, 600 μm, 700 μm, 800 μm, 900 μm, and 1000 μm to an upper limit of about 2000 μm, 1900 μm, 1800 μm, 1700 μm, 1600 μm, 1500 μm, 1400 μm, 1300 μm, 1200 μm, 1100 μm, and 1000 μm, encompassing any value and subset therebetween. The proppant particulates may be present in the proppant fluids of the present disclosure in an amount in the range of from a lower limit of about 0.1 pounds per gallon (lbm/gal), 0.5 lbm/gal, 1 lbm/gal, 1.5 lbm/gal, 2 lbm/gal, 2.5 lbm/gal, 3 lbm/gal, 3.5 lbm/gal, 4 lbm/gal, 4.5 lbm/gal, 5 lbm/gal, 5.5 lbm/gal, 6 lbm/gal, 6.5 lbm/gal, 7 lbm/gal, 7.5 lbm/gal, 8 lbm/gal, 8.5 lbm/gal, 9 lbm/gal, 9.5 lbm/gal, and 10 lbm/gal to an upper limit of about 20 lbm/gal, 19.5 lbm/gal, 19 lbm/gal, 18.5 lbm/gal, 18 lbm/gal, 17.5 lbm/gal, 17 lbm/gal, 16.5 lbm/gal, 16 lbm/gal, 15.5 lbm/gal, 15 lbm/gal, 14.5 lbm/gal, 14 lbm/gal, 13.5 lbm/gal, 13 lbm/gal, 12.5 lbm/gal, 12 lbm/gal, 11.5 lbm/gal, 11 lbm/gal, 10.5 lbm/gal, and 10 lbm/gal of the aqueous base fluid in the treatment fluid, encompassing any value and subset therebetween. Each of these values is critical to the embodiments of the present disclosure, and the size and amount of proppant particulates may depend on a number of factors including, but not limited to, the size and geometry of the main and/or branch fracture(s), the type of proppant particulates selected, the shape of the proppant particulates selected, and the like.

In some embodiments, the treatment fluids and/or proppant fluids of the present disclosure may further comprise an additive, provided that the additive does not interfere with the fluidic seal of the present disclosure. Suitable additives may include, but are not limited to, a salt, a weighting agent, an inert solid, a fluid loss control agent, an emulsifier, a dispersion aid, a corrosion inhibitor, an emulsion thinner, an emulsion thickener, a viscosifying agent, a gelling agent, a surfactant, a lost circulation material, a foaming agent, a gas, a pH control additive, a breaker, a biocide, a crosslinker, a stabilizer, a chelating agent, a scale inhibitor, a gas hydrate inhibitor, an oxidizer, a reducer, a friction reducer, a clay stabilizing agent, and any combination thereof.

In various embodiments, systems configured for delivering the treatment fluids and proppant fluids (collectively referred to simply as “fluids” below) described herein to a downhole location are described. In various embodiments, the systems can comprise a pump fluidly coupled to a tubular, the tubular containing the fluids described herein. It will be appreciated that while the system described below may be used for delivering either or both of the treatment fluid and/or proppant fluid, each fluid is delivered separately into the subterranean formation.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the fluids to a subterranean formation at or above a fracture gradient of the subterranean formation, but it may also be used in cases where fracturing is not desired. In some embodiments, the high pressure pump may be capable of fluidly conveying particulate matter, such as the micro-sized proppant particulates and/or the micro-sized proppant particulates described in some embodiments herein, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the fluids to the high pressure pump. In such embodiments, the low pressure pump may “step up” the pressure of the fluids before reaching the high pressure pump.

In some embodiments, the systems described herein can further comprise a mixing tank that is upstream of the pump and in which the fluids are formulated. In various embodiments, the pump (e.g., a low pressure pump, a high pressure pump, or a combination thereof) may convey the fluids from the mixing tank or other source of the fluids to the tubular. In other embodiments, however, the fluids may be formulated offsite and transported to a worksite, in which case the fluid may be introduced to the tubular via the pump directly from its shipping container (e.g., a truck, a railcar, a barge, or the like) or from a transport pipeline. In either case, the fluids may be drawn into the pump, elevated to an appropriate pressure, and then introduced into the tubular for delivery downhole.

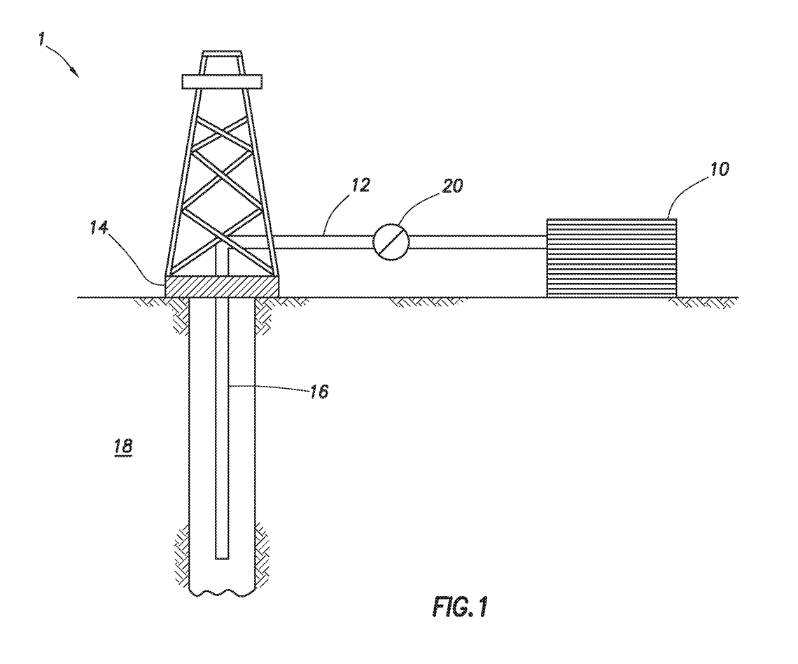

FIG. 1 shows an illustrative schematic of a system that can deliver the fluids of the present disclosure to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which the fluids of the embodiments herein may be formulated. The fluids may be conveyed via line 12 to wellhead 14, where the fluids enter tubular 16, tubular 16 extending from wellhead 14 into subterranean formation 18. Upon being ejected from tubular 16, the fluids may subsequently penetrate into subterranean formation 18. Pump 20 may be configured to raise the pressure of the fluids to a desired degree before introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the fluid may, in some embodiments, flow back to wellhead 14 and exit subterranean formation 18. In some embodiments, the fluid that has flowed back to wellhead 14 may subsequently be recovered and recirculated to subterranean formation 18.

It is also to be recognized that the disclosed fluids may also directly or indirectly affect the various downhole equipment and tools that may come into contact with the fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

Embodiments disclosed herein include:

### Embodiment A

A method comprising: (a) introducing a treatment fluid into a wellbore in a subterranean formation and through a perforation into a first propped main fracture at a first treatment interval at a rate and pressure above a fracture gradient of the subterranean formation, the treatment fluid comprising a first aqueous base fluid, expandable particulates, and degradable particulates, wherein the perforation fluidly connects the wellbore and the first propped main fracture, and wherein the expandable particulates are selected from the group consisting of hyaluronic acid-based particulates, hyaluronic acid-based coated particulates, a blowing agent encapsulated by an expandable material, a memory foam, and any combination thereof; (b) expanding the expandable particulates to fluidically seal the first propped main fracture to fluid flow between the first propped main fracture and the wellbore with the expanded expandable particulates and the degradable particulates; (c) diverting the treatment fluid to a second treatment interval in the subterranean formation along the wellbore, wherein the rate of the treatment fluid creates or enhances a second main fracture therein; (d) introducing a proppant fluid comprising a second aqueous base fluid and proppant particulates into the wellbore at the second treatment interval; and (e) placing the proppant particulates into the second main fracture, thereby forming a second propped main fracture.

Embodiment A may have one or more of the following additional elements in any combination:

### Element A1

Further comprising (f) degrading the degradable particulates.

### Element A2

Wherein the first propped main fracture and the second propped main fracture are fluidically interconnected, thereby increasing fracture network complexity.

### Element A3

Wherein the first propped main fracture and the second propped main fracture are fluidically interconnected at a near-wellbore location between about 1.5 meters and about 10 meters into the subterranean formation from the wellbore.

### Element A4

Wherein the first propped main fracture and the second propped main fracture are fluidically interconnected at a far field-wellbore location between about 11 meters to about 300 meters into the subterranean formation from the wellbore.

### Element A5

Further comprising repeating steps (a) through (e) at one or more additional treatment intervals in the subterranean formation.

### Element A6

Wherein particulates selected from the group consisting of the expandable particulates, the degradable particulates, and any combination thereof are coated with a coating agent selected from the group consisting of a tackifying agent, a hydrophobic agent, a relative permeability modifier, and any combination thereof.

### Element A7

Wherein particulates selected from the group consisting of the expandable particulates, the degradable particulates, and any combination thereof are encapsulated in an encapsulating material.

### Element A8

Wherein the blowing agent is selected from the group consisting of a hydrocarbon, liquid carbon dioxide, isocyanate, sodium bicarbonate, an azo-based material, a hydrazine-based material, a nitrogen-based material, a titanium hydride, a zirconium (II) hydride, and any combination thereof.

### Element A9

Further comprising a tubular extending into the low-permeability subterranean formation, and a pump fluidly coupled to the tubular, wherein a treatment fluid selected from the group consisting of the first treatment fluid, the second treatment fluid, and any combination thereof is introduced into the low-permeability subterranean formation through the tubular.

By way of non-limiting example, exemplary combinations applicable to A include: A with A1, A3, and A9; A with A2, A4, and A8; A with A1, A2, A3, A4, A5, A6, A7, A8, and A9; A with A5, A6, and A8; A with A1, A4, A8, and A9; A with A4 and A7; A with A3, A7, and A9; and the like.

### Embodiment B

A method comprising: (a) introducing a treatment fluid into a wellbore in a subterranean formation and through a perforation into a first main fracture comprising a first propped branch fracture at a first treatment interval at a rate and pressure above a fracture gradient of the subterranean formation, the treatment fluid comprising a first aqueous base fluid, expandable particulates, and degradable particulates, wherein the perforation fluidly connects the wellbore and the first main fracture, and wherein the expandable particulates are selected from the group consisting of hyaluronic acid-based particulates, hyaluronic acid-based coated particulates, a blowing agent encapsulated by an expandable material, a memory foam, and any combination thereof; (b) expanding the expandable particulates to fluidically seal the first propped branch fracture to fluid flow between the first propped branch fracture and the wellbore with the expanded expandable particulates and the degradable particulates; (c) diverting the treatment fluid to a second treatment interval in the first main fracture, wherein the rate of the treatment fluid creates or enhances a second branch fracture therein; (d) introducing a proppant fluid comprising a second aqueous base fluid and proppant particulates into the wellbore at the second treatment interval; and (e) placing the proppant particulates into the second branch fracture, thereby forming a second propped branch fracture.

Embodiment B may have one or more of the following additional elements in any combination:

### Element B1

Further comprising (f) placing the proppant particulates into the first main fracture, thereby forming a first propped main fracture.

### Element B2

Further comprising (f) degrading the degradable particulates.

### Element B3

Wherein the first propped branch fracture and the second propped branch fracture are fluidically interconnected, thereby increasing fracture network complexity.

### Element B4

Wherein the first propped branch fracture and the second propped branch fracture are fluidically interconnected at a near-wellbore location between about 1.5 meters and about 10 meters into the subterranean formation from the wellbore.

### Element B5

Wherein the first propped branch fracture and the second propped branch fracture are fluidically interconnected at a far field-wellbore location between about 11 meters to about 300 meters into the subterranean formation from the wellbore.

### Element B6

Further comprising repeating steps (a) through (e) at one or more additional treatment intervals in the first propped main fracture.

### Element B7

Wherein particulates selected from the group consisting of the expandable particulates, the degradable particulates, and any combination thereof are coated with a coating agent selected from the group consisting of a tackifying agent, a hydrophobic agent, a relative permeability modifier, and any combination thereof.

### Element B8

Wherein particulates selected from the group consisting of the expandable particulates, the degradable particulates, and any combination thereof are encapsulated in an encapsulating material.

### Element B9

Further comprising a tubular extending into the low-permeability subterranean formation, and a pump fluidly coupled to the tubular, wherein a treatment fluid selected from the group consisting of the first treatment fluid, the second treatment fluid, and any combination thereof is introduced into the low-permeability subterranean formation through the tubular.

By way of non-limiting example, exemplary combinations applicable to B include: B with B1 and B8; B with B2, B4, B6, and B9; B with B3, B5, and B6; B with B1, B2, B3, B4, B5, B6, B7, B8, and B9; B with B1, B4, B7, B8 and B9; B with B2, V3, and B4; B with B5 and B7; and the like.

Therefore, the embodiments disclosed herein are well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
(a) introducing a treatment fluid into a wellbore in a subterranean formation and through a perforation into a first propped main fracture at a first treatment interval at a rate and pressure above a fracture gradient of the subterranean formation, the treatment fluid comprising a first aqueous base fluid, expandable particulates, and degradable particulates,
wherein the perforation fluidly connects the wellbore and the first propped main fracture, and
wherein the expandable particulates are selected from the group consisting of hyaluronic acid-based particulates, hyaluronic acid-based coated particulates, a blowing agent encapsulated by an expandable material, a memory foam, and any combination thereof;
(b) expanding the expandable particulates to fluidically seal the first propped main fracture to fluid flow between the first propped main fracture and the wellbore with the expanded expandable particulates and the degradable particulates;
(c) diverting the treatment fluid to a second treatment interval in the subterranean formation along the wellbore, wherein the rate of the treatment fluid creates or enhances a second main fracture therein;
(d) introducing a proppant fluid comprising a second aqueous base fluid and proppant particulates into the wellbore at the second treatment interval; and
(e) placing the proppant particulates into the second main fracture, thereby forming a second propped main fracture.

2. The method of claim 1, further comprising (f) degrading the degradable particulates.

3. The method of claim 1, wherein the first propped main fracture and the second propped main fracture are fluidically interconnected, thereby increasing fracture network complexity.

4. The method of claim 1, wherein the first propped main fracture and the second propped main fracture are fluidically interconnected at a near-wellbore location between about 1.5 meters and about 10 meters into the subterranean formation from the wellbore.

5. The method of claim 1, wherein the first propped main fracture and the second propped main fracture are fluidically interconnected at a far field-wellbore location between about 11 meters to about 300 meters into the subterranean formation from the wellbore.

6. The method of claim 1, further comprising repeating steps (a) through (e) at one or more additional treatment intervals in the subterranean formation.

7. The method of claim 1, wherein particulates selected from the group consisting of the expandable particulates, the degradable particulates, and any combination thereof are coated with a coating agent selected from the group consisting of a tackifying agent, a hydrophobic agent, a relative permeability modifier, and any combination thereof.

8. The method of claim 1, wherein particulates selected from the group consisting of the expandable particulates, the degradable particulates, and any combination thereof are encapsulated in an encapsulating material.

9. The method of claim 1, wherein the blowing agent is selected from the group consisting of a hydrocarbon, liquid carbon dioxide, isocyanate, sodium bicarbonate, an azo-based material, a hydrazine-based material, a nitrogen-based material, a titanium hydride, a zirconium (II) hydride, and any combination thereof.

10. The method of claim 1, further comprising a tubular extending into the low-permeability subterranean formation, and a pump fluidly coupled to the tubular,
wherein a treatment fluid selected from the group consisting of the first treatment fluid, the second treatment fluid, and any combination thereof is introduced into the low-permeability subterranean formation through the tubular.

11. A method comprising:
(a) introducing a treatment fluid into a wellbore in a subterranean formation and through a perforation into a first main fracture comprising a first propped branch fracture at a first treatment interval at a rate and pressure above a fracture gradient of the subterranean formation, the treatment fluid comprising a first aqueous base fluid, expandable particulates, and degradable particulates,
wherein the perforation fluidly connects the wellbore and the first main fracture, and
wherein the expandable particulates are selected from the group consisting of hyaluronic acid-based particulates, hyaluronic acid-based coated particulates, a blowing agent encapsulated by an expandable material, a memory foam, and any combination thereof;
(b) expanding the expandable particulates to fluidically seal the first propped branch fracture to fluid flow between the first propped branch fracture and the wellbore with the expanded expandable particulates and the degradable particulates;
(c) diverting the treatment fluid to a second treatment interval in the first main fracture, wherein the rate of the treatment fluid creates or enhances a second branch fracture therein;
(d) introducing a proppant fluid comprising a second aqueous base fluid and proppant particulates into the wellbore at the second treatment interval; and
(e) placing the proppant particulates into the second branch fracture, thereby forming a second propped branch fracture.

12. The method of claim 11, further comprising (f) placing the proppant particulates into the first main fracture, thereby forming a first propped main fracture.

13. The method of claim 11, further comprising (f) degrading the degradable particulates.

14. The method of claim 11, wherein the first propped branch fracture and the second propped branch fracture are fluidically interconnected, thereby increasing fracture network complexity.

15. The method of claim 11, wherein the first propped branch fracture and the second propped branch fracture are fluidically interconnected at a near-wellbore location between about 1.5 meters and about 10 meters into the subterranean formation from the wellbore.

16. The method of claim 11, wherein the first propped branch fracture and the second propped branch fracture are fluidically interconnected at a far field-wellbore location between about 11 meters to about 300 meters into the subterranean formation from the wellbore.

17. The method of claim 11, further comprising repeating steps (a) through (e) at one or more additional treatment intervals in the first propped main fracture.

18. The method of claim 11, wherein particulates selected from the group consisting of the expandable particulates, the degradable particulates, and any combination thereof are coated with a coating agent selected from the group consisting of a tackifying agent, a hydrophobic agent, a relative permeability modifier, and any combination thereof.

19. The method of claim 11, wherein particulates selected from the group consisting of the expandable particulates, the degradable particulates, and any combination thereof are encapsulated in an encapsulating material.

20. The method of claim 11, further comprising a tubular extending into the low-permeability subterranean formation, and a pump fluidly coupled to the tubular,
wherein a treatment fluid selected from the group consisting of the first treatment fluid, the second treatment fluid, and any combination thereof is introduced into the low-permeability subterranean formation through the tubular.
